(19) United States
(12) Patent Application Publication
(10) Pub. No.: US 2012/0042906 A1
(43) Pub. Date: Feb. 23, 2012

(54) Method and apparatus for cleaning a toothbrush

(76) Inventor: Raya Meerzoumen, New York, NY (US)

(21) Appl. No.: 12/806,794

(22) Filed: Aug. 23, 2010

(51) Int. Cl. B08B 7/04

(52) U.S. Cl. 134/18

(57) ABSTRACT

The invention provides a method of and apparatus for cleaning a toothbrush that is both easy to perform and effective. Brushing teeth is often performed just before going to sleep at a time that people are not inclined to engage in complicated or technical activities. As a result, consumers require a simple non-cumbersome method of cleaning toothbrushes. The inventive method involves a spray bottle dispensing a liquid cleaner to the toothbrush. This method is simple to perform and can be easily adjusted for the best angle or intensity needed to clean a toothbrush. Despite this simplicity it is elegant because it is directly controlled by the user and therefore can be adjusted dynamically in relationship to such factors as what a user just ate, or how a toothbrush looks, smells, or feels at a given moment.

### CROSS-REFERENCE TO RELATED APPLICATIONS

None.

### STATEMENT REGARDING FEDERALLY SPONSORED RESEARCH OR DEVELOPMENT

Not Applicable.

### BACKGROUND OF THE INVENTION

This invention relates to methods and apparatuses for the cleaning of toothbrushes. The overwhelming number of toothbrush users, regularly brush their teeth and then do little to clean their toothbrushes other than a quick rinse at the bathroom sink. As a result, food particles remain between the bristles of the brush and over time they accumulate. This food rich environment facilitates the growth of harmful bacteria such as E. coli and salmonella whose presence may lead to infection, illness and tooth decay.

A number of prior art approaches have been proposed to sanitize toothbrushes. US Published Applications 2008/0219883 and 2009/0010826 disclose electrical heating and cleaning mechanisms. US Published Application 2009/0120814 discloses a sanitizing fluid reservoir mechanism for toothbrushes. US Published Application 2009/0107857 discloses a toothbrush holder for cleaning bristles. US Published Application 2004/033182 discloses a heat and steam toothbrush cleaner. WO 2007/071031 describes an ultrasonic vibration toothbrush cleaner. DE 19957924 describes a microwave cleaner. US Published Application 2007/0295916 discloses an ultraviolet radiation toothbrush cleaner.

Unfortunately a common attribute of these prior art approaches is that they are very cumbersome and are not compatible with the expectations people have of ordinary bathroom use. Majority of bathroom users expect that brushing teeth will be a simple hassle free experience, which requires nothing more than a toothbrush, toothpaste, and a sink or other water source. This is because brushing teeth occurs either just before or after sleep when users are unwilling or don't want to engage in complicated activities. To require that a brusher also needs to supply an electrical source, storage space for complex mechanisms, and maintenance routines for those mechanisms contradicts the expectations that brushers have of how simple and routine their teeth brushings should be.

Thus there is clear need and utility for an improved method and apparatus for the cleaning of toothbrushes. The art described in this section is not intended to constitute an admission that any patent, publication or other information referred to herein is “prior art” with respect to this invention, unless specifically designated as such. In addition, this section should not be construed to mean that a search has been made or that no other pertinent information as defined in 37 C.F.R. §1.56(a) exists.

### BRIEF SUMMARY OF THE INVENTION

At least one embodiment of the invention is directed towards a method of cleaning a toothbrush. The method comprises spraying an effective amount of droplets of a cleaning fluid from a spray bottle nozzle into the bristles of a toothbrush, the droplets being dispensed from a spray bottle. The spray bottle can be hand powered. The spray bottle can be in a location lacking electricity. The method can further comprise the steps of observing which distance between the spray bottle nozzle and the bristles is optimal and spraying from that distance. The method can further comprise the steps of spraying the droplets more than one time from more than one distance. The method can further comprise the steps of spraying the droplets more than one time along different angles relative to an axis selected from the group consisting of the proximal, longitudinal, and lateral angles, and any combination thereof. The cleaning fluid can be a composition of matter comprising: eucalyptol, menthol, methyl salicylate, thymol, cetylpyridinium chloride, chlorhexidine, and any combination thereof. The cleaning fluid can disinfect the toothbrush bristles. The method can further comprise the step of rubbing the bristles with a rigid member substantially contemporaneous to brushing teeth. The rigid member can be a human finger or second toothbrush. The method can further comprise the step of spraying more than one toothbrush at a time.

### BRIEF DESCRIPTION OF THE DRAWINGS

A detailed description of the invention is hereafter described with specific reference being made to the drawings in which:

FIG. 1 is an illustration of the novel method of toothbrush cleaning.

FIG. 2 is an illustration of the angles in which the novel method of toothbrush cleaning can be applied.

### DETAILED DESCRIPTION OF THE INVENTION

For purposes of this application the definition of these terms is as follows:

“Spray Bottle” means an apparatus having a fluid holding reservoir, a nozzle, and a mechanism which when activated dispenses the fluid through the nozzle.

“Substantially Contemporaneous” means moments before or moments after a particular activity or event.

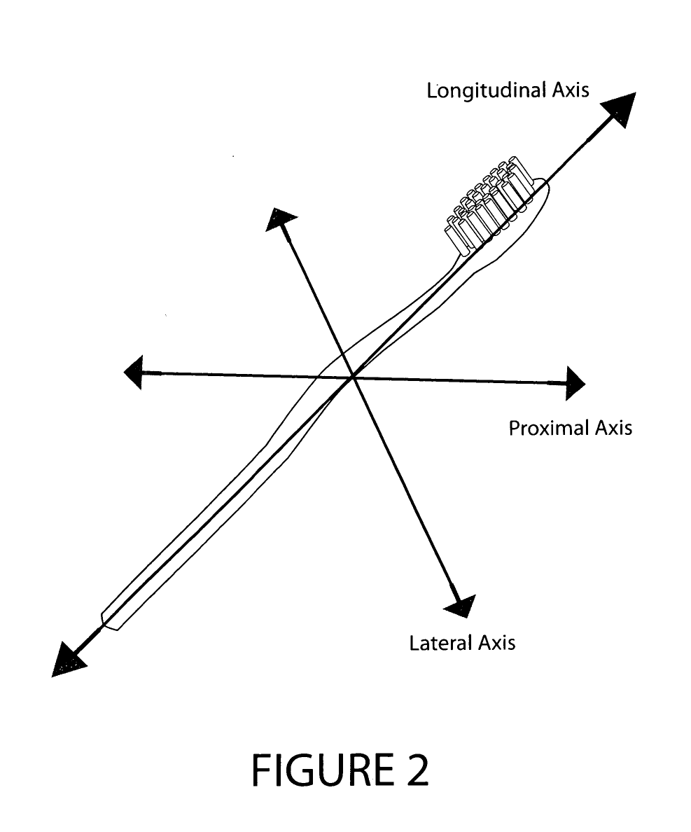

“Longitudinal Axis” as illustrated in FIG. 2, means an axis extending along the path generally defined by a line extending between the bristles farthest from the toothbrush handle and the toothbrush handle.

“Lateral Axis” as illustrated in FIG. 2, means an axis extending to the left and right of the longitudinal axis as viewed from a perspective in which the bristles are facing the viewer and are above the toothbrush handle.

“Proximal Axis” as illustrated in FIG. 2, means an axis extending in front of and behind the longitudinal axis as viewed from a perspective in which the bristles are facing the viewer and are above the toothbrush handle.

In the event that the above definitions or a definition stated elsewhere in this application is inconsistent with a meaning (explicit or implicit) which is commonly used, in a dictionary, or stated in a source incorporated by reference into this application, the application and the claim terms in particular are understood to be construed according to the definition in this application, and not according to the common definition, dictionary definition, or the definition that was incorporated by reference.

In at least one embodiment a spray bottle is positioned near the toothbrush and dispenses an effective dosage of disinfecting liquid droplets against the toothbrush head. Although simpler than the prior art, the spray bottle is in fact more effective and useful. A hand powered spray bottle does not require a power source, is easy to store, and is of the sort of equipment already present in a bathroom in such forms as hairspray and shampoo bottles. Moreover, little to no planning or foresight is needed to effectively clean a toothbrush. The user merely positions the toothbrush adjacent to the nozzle of the spray bottle, and sprays the toothbrush after and/or before brushing teeth. While elegant and effective, this approach has not been contemplated by the prior art as the prior art has focused on cumbersome automated and electrical devices. Finally, unlike the automated equipment, the spray bottle is portable and is suitable for outdoor uses such as camping and hikes or other situations where electricity is not available or where portable electrical sources are not available or desired. Examples of suitable spray bottles are disclosed in U.S. Pat. Nos. 6,540,119 and 5,899,366.

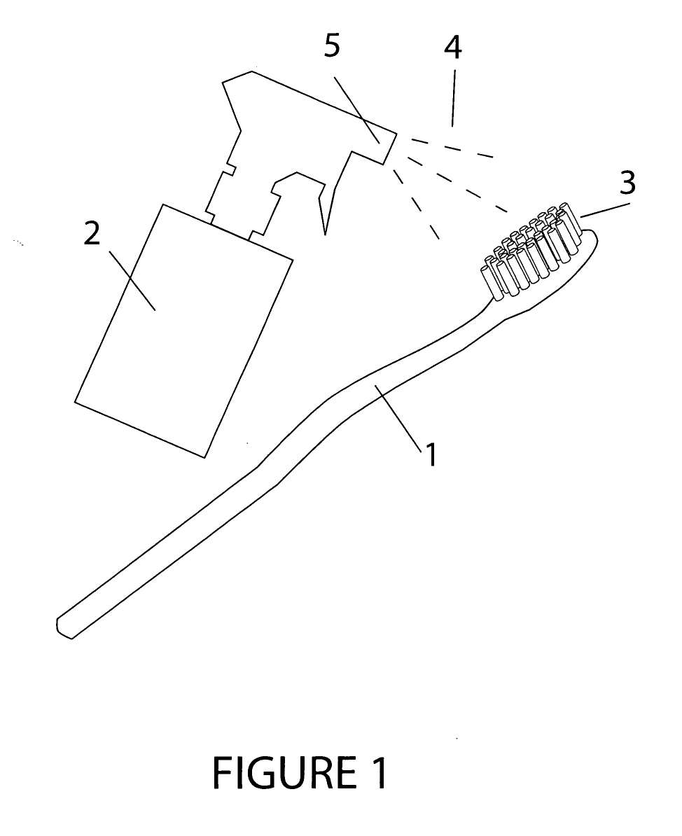

Referring now to FIG. 1 there is shown (1) a toothbrush, being cleaned by a spray bottle (2). The spray bottle (2) emits a number of droplets (4) that penetrate between the bristles (3) of the toothbrush (1). In at least one embodiment, the position of the spray nozzle (5) is adjusted relative to the spacing of the bristles (3). The user moves the bottle closer to the bristles to distribute droplets to narrowly spaced bristles (3) or farther back for widely spaced bristles. In at least one embodiment, the spray bottle comprises an adjustable setting for altering the droplet stream intensity and/or distribution and thereby reduces or increases the application of the droplets depending on the respective rigidity or softness of the bristles (3). In at least one embodiment, a hand powered spray bottle is sprayed more or less vigorously relative to the optimal spray intensity for the particular toothbrush being cleaned.

The elegance of the invention is apparent in the fact that the position of the bristles to the nozzle is highly variable and thereby can be optimized in manners that the more cumbersome and rigid prior art cannot. Often, a user cannot know where within the bristles the particles are located and from which angle would a droplet stream most effectively dislodge them. Alternatively it might be known just before or after brushing but not at the time that the automated apparatus is set. By using a spray bottle, the angle of the droplet stream can be varied relative to the longitudinal axis, lateral axis, or proximal axis or any combination thereof. Moreover unlike with automated devices, this adjustment is extremely simple and therefore is “idiot proof” and consistent with user's desire for an uncomplicated tooth brushing experience.

In at least one embodiment, the bristles (3) are sprayed from more than one direction relative to the longitudinal, lateral, or proximal axes, or any combination thereof. In at least one embodiment, the user can adjust the dosage of sanitizing liquid daily by simply spraying more liquid. This allows users to dynamically adjust their cleaning routines relative to information that an automatic system can't have such as what the user had for dinner before brushing and/or how dirty the brush became after a particular brushing, and/or how a brush looks, smells, or feels at a given time.

In at least one embodiment, prior to, during, or after spraying, the user brushes the bristles (3) with a rigid member such as a finger or other item. This brushing motion, when done substantially contemporaneous to spraying the bristles (3), dislodges particles and enhances the effectiveness of the sprayed droplets (4). In at least one embodiment the rigid member is another toothbrush. In at least one embodiment more than one toothbrush is sprayed at the same time. In at least one embodiment the rigid member is the nozzle (5) or other portion of the spray bottle (2).

In at least one embodiment, the liquid disinfectant is a composition of matter comprising: eucalyptol, menthol, methyl salicylate, thymol, cetylpyridinium chloride, chlorhexidine, and any combination thereof.

While this invention may be embodied in many different forms, there are shown in the drawings and described in detail herein specific preferred embodiments of the invention. The present disclosure is an exemplification of the principles of the invention and is not intended to limit the invention to the particular embodiments illustrated. All patents, patent applications, scientific papers, and any other referenced materials mentioned herein are incorporated by reference in their entirety. Furthermore, the invention encompasses any possible combination of some or all of the various embodiments described herein and incorporated herein.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

All ranges and parameters disclosed herein are understood to encompass any and all subranges subsumed therein, and every number between the endpoints. For example, a stated range of “1 to 10” should be considered to include any and all subranges between (and inclusive of) the minimum value of 1 and the maximum value of 10; that is, all subranges beginning with a minimum value of 1 or more, (e.g. 1 to 6.1), and ending with a maximum value of 10 or less, (e.g. 2.3 to 9.4, 3 to 8, 4 to 7), and finally to each number 1, 2, 3, 4, 5, 6, 7, 8, 9, and 10 contained within the range.

This completes the description of the preferred and alternate embodiments of the invention. Those skilled in the art may recognize other equivalents to the specific embodiment described herein which equivalents are intended to be encompassed by the claims attached hereto.

1. A method of cleaning a toothbrush comprising the steps of:
spraying an effective amount of droplets of a cleaning fluid from a spray bottle nozzle into the bristles of a toothbrush, the droplets being dispensed from a spray bottle.

2. The method of claim 1 in which the spray bottle is hand powered.

3. The method of claim 1 in which the spray bottle is in a location lacking electricity.

4. The method of claim 1 further comprising the steps of observing which distance between the spray bottle nozzle and the bristles is optimal and spraying from that distance.

5. The method of claim 1 further comprising the steps of spraying the droplets more than one time from more than one distance.

6. The method of claim 1 further comprising the steps of spraying the droplets more than one time along different angles relative to an axis selected from the group consisting of the proximal, longitudinal, and lateral angles, and any combination thereof.

7. The method of claim 1 in which the cleaning fluid is a composition of matter comprising: eucalyptol, menthol, methyl salicylate, thymol, cetylpyridinium chloride, chlorhexidine, and any combination thereof.

8. The method of claim 1 in which the cleaning fluid disinfects the toothbrush bristles.

9. The method of claim 1 further comprises the step of rubbing the bristles with a rigid member substantially contemporaneous to brushing teeth.

10. The method of claim 9 in which the rigid member is a human finger or second toothbrush.

11. The method of claim 1 further comprising the step of spraying more than one toothbrush at a time.
